(19) United States
(12) Patent Application Publication
(10) Pub. No.: US 2009/0242724 A1
(43) Pub. Date: Oct. 1, 2009

(54) ADVERTISING PANEL SUPPORT DEVICE

(76) Inventor: Serge Jose Do Camo, Pontault-Cornhaul (FR)

Correspondence Address: FISH & RICHARDSON PC, P.O. BOX 1022, MINNEAPOLIS, MN, 55440-1022, US

(21) Appl. No.: 10/596,772

(22) PCT Filed: Dec. 13, 2004
(86) PCT No.: PCT/FR04/03197

§ 371 Date: Jun. 27, 2007

(30) Foreign Application Priority Data
Dec. 31, 2003 (FR) 03/15596

(51) Int. Cl. F16M 13/00

(52) U.S. Cl. 248/560

(57) ABSTRACT

The invention relates to a device which is used to hold in place a repositionable element that is subjected to loads from a force, e.g. a weight, and, more specifically, a fluid, e.g. a moving liquid or a gas. The inventive device is designed such that, when a force exerts a pressure on the element, at least one elastic mounting means (14, 15, 16, 17) is compressed and at least one elastic mounting means (14, 15, 16, 17) is extended, thus maintaining the element solidly connected to the movement device on the support.

### TECHNICAL FIELD

The present invention relates to a device used to hold a repositionable load in a vertical position, more specifically, a repositionable sign, which is subject to. force, for example, weight, more specifically a fluid, for example, a gas or a liquid in movement. Moreover, the present invention relates to a device which allows a vertical sign to be supported while it is subject to the action of air, wind or rain, which exerts a considerable perpendicular force against the sign. Even more specifically, the present invention relates to a device to hold a sign in an essentially vertical position, which is subject to the action of the air which is moving in a perpendicular direction across the sign, such as for example, a sign connected to the roof of a vehicle and on a plane which is perpendicular to the vehicle's direction of movement.

### BACKGROUND OF THE INVENTION

Several devices for holding a flat sign on the roof of a vehicle are known. The sign may serve as advertising or for information. It must be possible to assemble and dismantle these signs easily on the roof of the vehicle without damaging the bodywork. Furthermore, the signs must be able to resist the force of the air which acts upon the signs when the vehicle moves.

U.S. Pat. No 1,942,444, granted to F. J. O'CONNOR, on Feb. 1, 1933, describes a device to hold a sign on a vehicle, with the signs placed parallel to the direction of the vehicle's movement, (i.e., lengthwise on the vehicle). The objective of this device is to hold the sign firmly and yet elastically opposite the lateral pressure from the wind. For this purpose, the sign is supported by a system of metal straps.

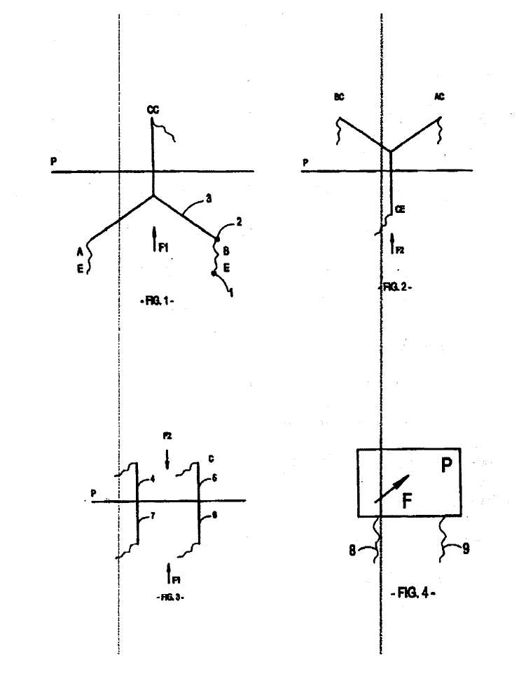

French patent application No 2.658.643, describes a magnetic support for informational signs. This patent application mentions the above technique in its description, “that there are magnetic supports which are able, on the one hand, to be placed on any metal surface upon which they are then held by magnetic adherence, and on the other hand, are able to receive some sort of mechanical connection that will anchor them to various objects, such as for example, informational signs. When these signs and their supports must be exposed to the outside and undergo the action of the wind, then the mechanical connection generally consists of a spring which makes it possible for the sign to tilt under the force of the wind without tearing off the magnetic support.” Thus, according to the above technique that this patent application describes, the signs are tilted under the force of the wind. When referring to FIG. 1 of this document, it can be seen that the sign is placed parallel to the vehicle's direction of movement, (i.e., lengthwise on the vehicle). The differences between this document FR-A-2 658.643, which is regarded as the manner closest to the technique, will be explained further by referring to the annexed drawings.

All the devices of the former technique attempt to provide a device to hold a sign on the roof of a vehicle, which may be easily positioned on the vehicle, which may be easily removed from the vehicle, without damaging the body of the vehicle, and that would be resistant to inclement weather like rain and more specifically, wind. Devices of prior techniques only take into consideration supporting an essentially flat sign placed only lengthwise on a vehicle, (i.e., parallel to the vehicle's direction of movement). These signs, which are intended to consist of writing, as in the case, for example, of information or advertisement, are seen primarily by people that are found in a lateral position relative to the vehicle and therefore primarily by pedestrians moving on walkways parallel to the direction of the vehicle's movement. On the other hand, the drivers of other vehicles are in front of or behind the vehicle carrying the advertising sign and will not be able to see the information placed on the sign. However, the majority of the consumers for which the information on the sign is intended, are users that are either in private vehicles, or in public transportation vehicles. The interest in an advertising sign placed lengthwise on a vehicle, (i.e., in the direction in which the vehicle is moving), is lower than the interest in an advertising sign placed perpendicular to the direction in which the vehicle is moving. The proof is that certain owners of vehicles, such as taxis, have attached advertisements sideways. However, this type of advertisement has not been chosen by owners of private vehicles because visibility of advertisements is not accessible to the drivers or passengers in other vehicles. On the other hand, large volume public transport vehicles, like trolley cars or buses, have placed advertisements not only on their side walls, but also on their back walls. In this last case, advertisements on the back are much more visible by the drivers of vehicles behind the trolley car or the bus and the placement of these very visible advertisements on the back of the vehicle are more beneficial for those that lease advertising space than placing advertisements the side of trolley cars or buses.

Consequently, the objective of the present invention is to provide a holding device upon a support that will hold a sign perpendicular to the vehicle's direction of movement, and consequently is perpendicular to the force exerted by air, wind and/or rain, which is much stronger in this case, than if the sign is placed lengthwise on the vehicle, (i.e., parallel to the direction of movement). This holding device, to be set upon a sign support perpendicular to a fluid force such as the air, the wind and/or the rain, snow, etc, must also maintain the sign in an essentially vertical position. Indeed, if the sign leans too much under the fluid force, it would not allow the informational or advertising message to be read.

Consequently, another objective of the present invention is to provide a holding device on a sign support perpendicular to the fluid force, and in an essentially vertical position.

Another objective of the present invention is to provide a holding device on a sign support perpendicular to the fluid force, and in an essentially vertical position. Said device may be placed in an immobile manner upon said support.

Yet another objective of the present invention is to provide a holding device on a sign support perpendicular to the fluid force, and in an essentially vertical position.

Still another objective of the present invention is to put a load, which is subject to weight, into motion, while keeping it essentially in a vertical position. The load is repositionable.

### SUMMARY OF THE INVENTION

For this purpose, the present invention relates to a device used to put in motion a repositionable load, which is subject to a force impulse, such as is its weight, characterized in that it consists of at least one support arm that is connected to one end of an elastic mounting device with its opposite and interdependent end being a removable and repositionable attachment device upon the load, the aforementioned support arm is carried into motion by a drive device, the aforementioned device being such that when force is exerted upon the load, at least one elastic mounting device compresses, and at least one elastic mounting device extends, thereby temporarily steadying the interdependent load with the aforementioned motion device.

In accordance with one implementation, the present invention relates to a holding device on a repositionable sign support perpendicular to the fluid force, and in an essentially vertical position, characterized in that it consists of at least two support arms, each having one end connected to panel (sign) P and the opposite end connected to one end of an elastic mounting device with its opposite end joined to a removable attachment device on the load, the elastic devices being in a different direction from the direction of panel (sign) P, so that when the fluid exerts force upon the panel (sign), at least one elastic mounting device extends, thereby stabilizing the panel (sign) in its initial position.

In accordance with one implementation of the invention, the device is comprised of at least three elastic devices.

The device in accordance with the invention is comprised of the following characteristics:

The elastic devices are springs;

The elastic devices may be a piston-cylinder system;

The removable attachment devices are magnets;

The removable attachment devices are suction cups;

The support arms are brackets in the form of a triangle of which one side is joined to the sign;

Two support arms form an integral part of a support plaque which consists of the aforementioned arms joined at their sides connected to the panel.

The panel has transverse sections in the shape of a trapezoid, the height of which acts as the symmetrical axis of the device. The two ends of its large base are joined to two elastic devices and its sides are curved and concave.

In accordance with the invention, two devices may be placed side by side to vertically transport a repositionable load subject to its own weight.

The device, in accordance to the invention, may consist of a multitude of elastic device systems for removable attachment placed linearly.

### DETAILED DESCRIPTION OF THE INVENTION

The invention will be described more in detail in reference to the annexed drawings, in which:

FIG. 1 is a schematic view from the top of the holding device for supporting a sign in accordance with the present invention;

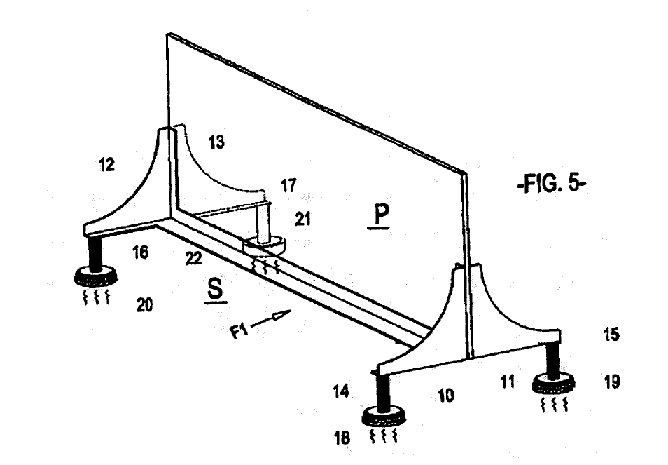

FIG. 2 is a schematic view from the top of the device in accordance with FIG. 1, turned 180 degrees;

FIG. 3 is a schematic view from the top of the another way of producing the device for holding a sign on a support, in accordance with the present invention;

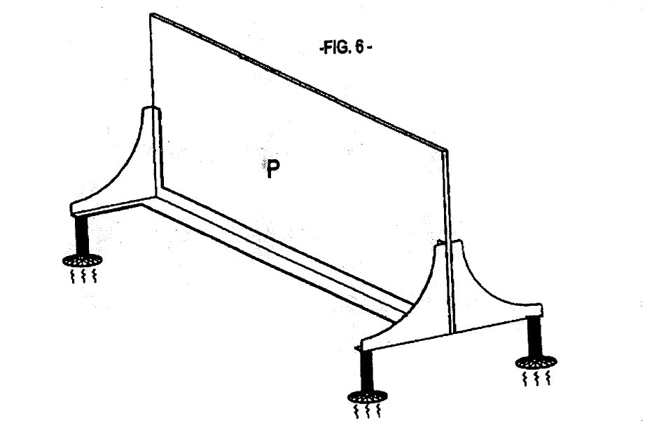

FIG. 4 is a schematic view of the device of the former technique described in document FR-A-2 658.643;

FIG. 5 is a view in perspective of the first implementation of the device in accordance with the present invention;

FIG. 6 is a view in perspective of the second implementation of the device in accordance with the present invention;

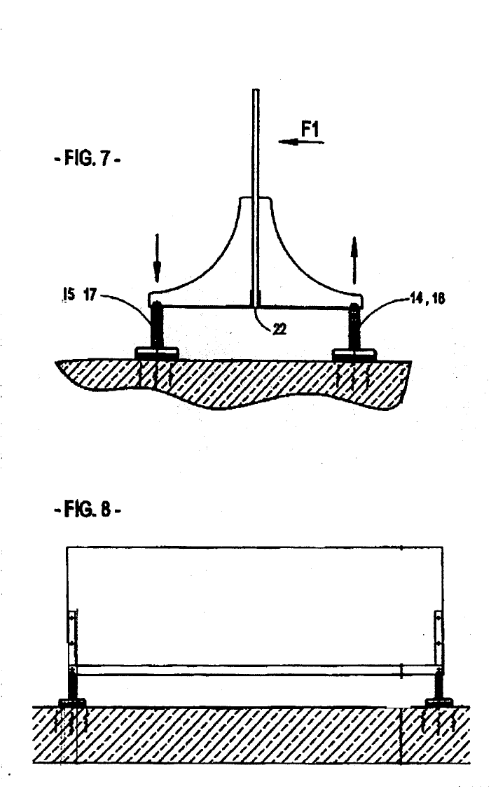

FIG. 7 is a profile view of the first implementation of the device in accordance with the present invention;

FIG. 8 is a front view of the first implementation of the device in accordance with the present invention;

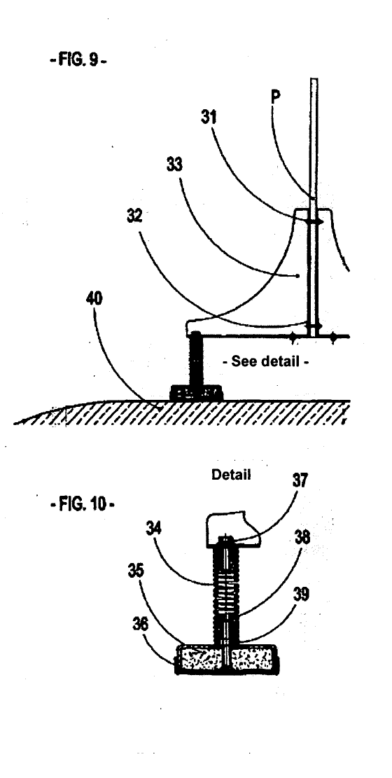

FIG. 9 is a partial profile view of the first implementation of the device in accordance with the present invention;

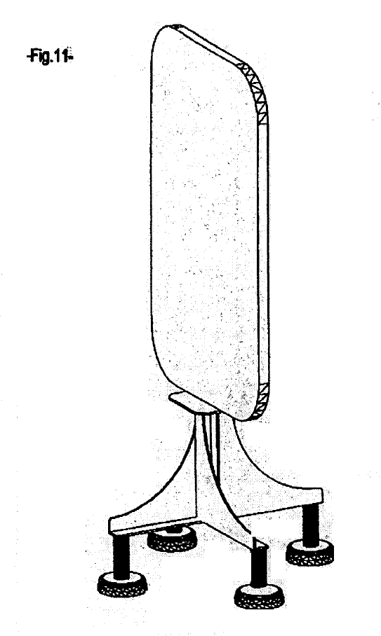

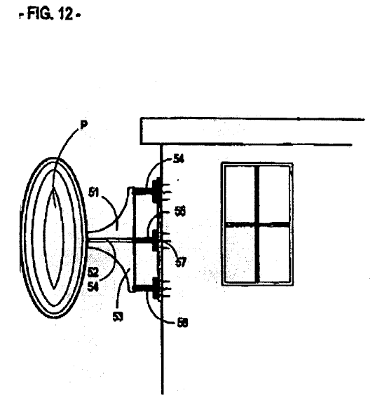

FIG. 10 is an enlarged view of the elastic device for attaching the sign on the support;

FIG. 11 is a view in perspective of the third implementation of the device in accordance with the present invention;

FIG. 12 is a front view of the fourth implementation of the device in accordance with the present invention;

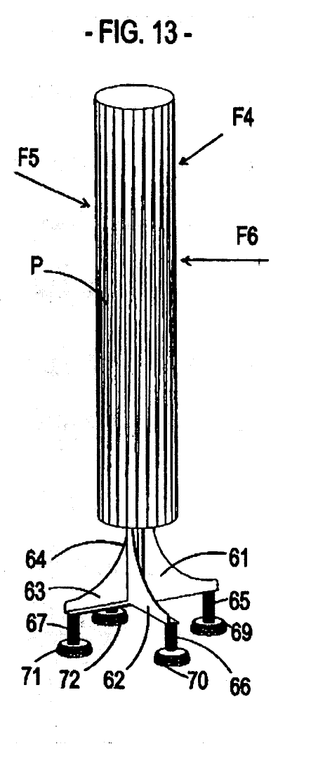

FIG. 13 is a front view of the fifth implementation of the device in accordance with the present invention;

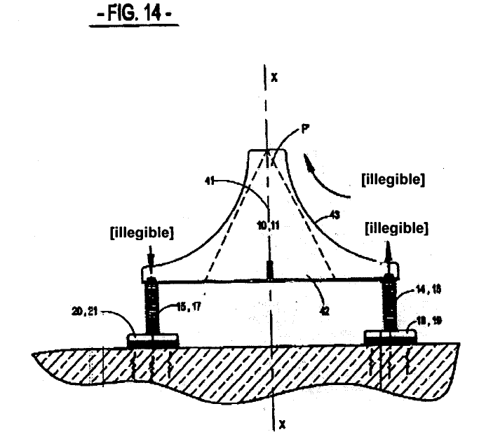

FIG. 14 is a front view of the sixth implementation of the device in accordance with the present invention; and

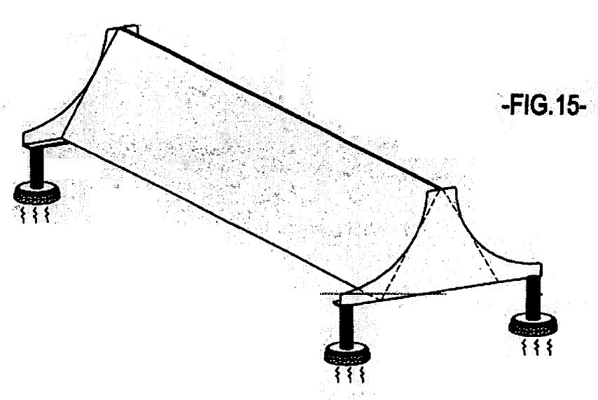

FIG. 15 is a view in perspective of the sixth implementation of the device shown in FIG. 14.

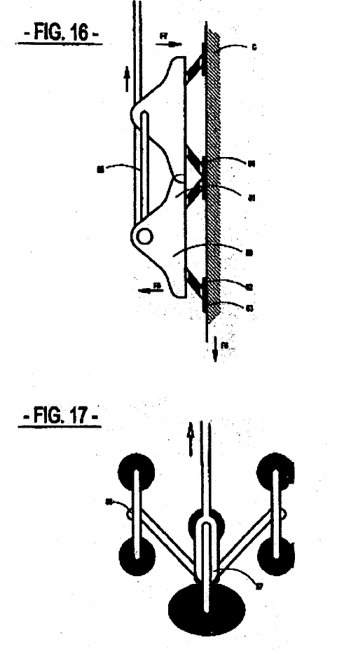

FIG. 16 is a front view of a set of two devices in accordance with the invention, placed side by side which allows a repositionable load to be held vertically.

FIG. 17 is a side view of the set according to FIG. 16.

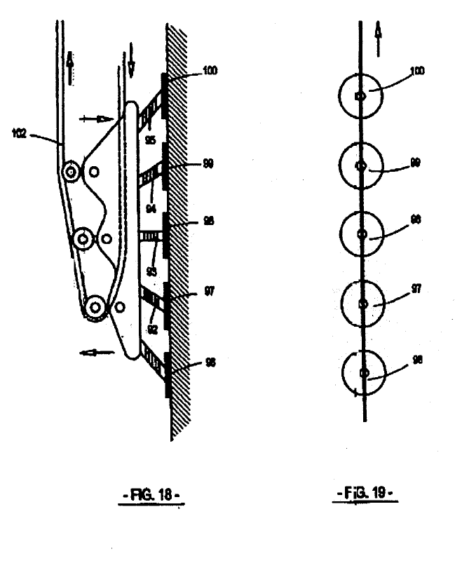

FIG. 18 is a front view of a device in accordance with the invention, which includes a multitude of removable elastic support systems.

FIG. 19 is a top view of the device according to FIG. 18.

FIG. 1 is a schematic representation of the device in accordance with the present invention which allows for a better understanding of its function. The device, according to the invention, includes a panel (P) which is less thick than its main surface, which, for example, may be rectangular. This main surface is thus subjected to the action of a fluid flowing in the direction shown by arrow F1, that is, a fluid exerting a force that is essentially perpendicular to the main surface of panel P. The fluid may, for example, exert its force in an oblique direction relative to the plane of the main surface of panel P. The fluid may be a gas in movement, like air, or a liquid, like water. According to the present invention, panel P is mounted upon a support (not shown in FIG. 1) which may, for example, be horizontal (see FIGS. 7 to 11, 13, 14) but, which may also be vertical, as shown in FIG. 12, by using at least three elastic devices, A, B, and C. These elastic mounting devices have one end (1) attached upon the support and the opposite end (2) joined to a support arm (3) on panel P. The purpose of the present invention is that panel P, attached to the support, does not detach under the force exerted by the fluid flowing in the direction of arrow F1, and does not bend away from its initial position. At least three elastic mounting devices (A, B, and C) are of the sort that, when the fluid exerts a force against the panel, at least one elastic mounting device will compress, and at least one elastic mounting device will be extended. In the case of FIG. 1, two elastic mounting devices (A, B), are extended, and one elastic mounting device (C) compresses. The devices which are extended are those (A_{E} and B_{E}, in the case of FIG. 1) that are initially subject to the action of the fluid, while the elastic mounting devices that compress, are those (C_{C} in the case of FIG. 1) that are subject to the action of the fluid force after the others. In FIG. 2, the elastic mounting device that extends is the one that is initially subject to the action of force F2, namely C_{E}, and the elastic mounting devices that compress are those that are subject to the action of the fluid force after the others and in the direction of arrow F2, namely B_{C} and A_{C}. The direction of arrow F2 is opposite to the direction of arrow F1.

Elastic mounting devices (A, B and C) may be coil springs, which are compressed and stretched according to their length, but which also may become distorted to an S-shape, during the fluid shift. It could also be made with a piston-cylinder system which would be capable of modifying length, but which, on the other hand, would not be capable of becoming distorted.

In FIG. 3, panel P is seen as being supported by using four support arms (4, 5, 6 and 7). Each one includes a spring. Two support arms (4, 5) are located on one side of panel P and the other two support arms (6, 7) are located on the side opposite panel P. The system functions in the same way as the preceding implementations. When panel P is subjected to the fluid force (in the direction of arrow F1), the springs on arms 6, 7 (which are initially subject to fluid force F1), are extended, while the springs on arms 4, 5 (which are subject to fluid force after the others) are compressed. Conversely, in the direction of the F2 arrow, (which is the opposite of the direction of arrow F1), springs on arms 4, 5 extend, while the springs on arms 6, 7 compress.

In accordance with the invention, the combined action of the elastic devices always maintains panel P in a vertical position. It will be noted that the elastic mounting devices on the panel are such that at least one elastic device is on a different plane than the plane of the main surface of panel P, therefore on a different plane than the surface of the panel that is undergoing the strongest fluid force.

In reference to FIG. 4 (which illustrates schematically a device of the former technique described in document FR-A-2 658.643), one sees that the panel P is supported by two springs (8, 9) which are located on the plane of the panel P. When the main surface of panel P is suddenly subject to a fluid force in the direction of the arrow F, (which is essentially perpendicular to the plane of the main surface), panel P will tilt, and as is explained in document FR-A-2 658.643, it will lie down on the support, i.e., in this case, against the surface of the roof of the vehicle. The principal attempt of this invention is to prevent this phenomenon from happening, and conversely, intends to keep the panel in an essentially vertical position.

While having explained the principle of this invention, the various implementations of this invention will now be explained more in detail.

FIG. 5 is a view in perspective of the first implementation of the device in accordance with the present invention; Panel P's support device, in accordance with the invention, is comprised of four support arms (10, 11, 12, 13), which make it possible to keep panel P vertical. These arms are in the shape of a bracket, which on one end is comprised of an elastic device (14, 15, 16, 17), and each one includes a removable attachment device (18, 19, 20, 21), respectively, on an S support. Each bracket is essentially a triangle, which supports panel P on one of its sides, and the opposite end on the opposite side supports the elastic device. It is necessary to point out that according to an essential characteristic of this invention, the elastic devices are on a different plane from the plane of panel P. As can be seen more specifically in FIG. 7, when the fluid exerts a force in the direction indicated by arrow F1 (in a direction perpendicular to the panel P), the elastic mounting devices (14, 16), (which are the first to undergo the first impulse of fluid in the direction of arrow F1), are extended, while the elastic mounting devices (15, 17) that are afterwards subject to the fluid force, are compressed. The elastic mounting devices (14, 15, 16, 17) are lengthwise and because of this go along the lower edge of the panel of support S. In this way, the fluid may pass under the lower edge (22) and thus its force is divided.

The removable and repositionable attachment devices (18, 19, 20, 21) are, for example, magnets, but may also be suction cups, as shown in FIG. 6. The magnets may be magnets with electric flux density which are activated when an electric current acts upon them and are deactivated when the electric current is shut off. One may use a number selected from elastic devices which each include a removable attachment device. The number of elastic device and attachment systems is important, plus the force of the tear strength is important.

In FIG. 9, a possible implementation of the invention is shown. Panel P is held by two angles (32) (made of aluminum, for example) per bolt (31). Four brackets (33) (made of steel, for example), are placed against both sides of panel P, and are attached by bolts (31) between each, and the entire thing is put together with bolts (31) at the two angles. The higher part of the springs (34) and attached to the lower part, at the end, of the brackets (33) on the side opposite panel P by screws (37) on the peg (38). [Translator's note: There may be a typo in the French, since there is no verb in this sentence.] The lower part of the springs (34) is attached by bolts (39) on magnet (35).

In FIG. 14, an improved device of this invention is shown. This is the best implementation yet of the invention. Panel P is not a flat panel, as before, but it is a panel where the front and back surfaces are distant from the vertical plane passing through the axis of symmetry (XX) of the device. Panel P follows the shape of brackets 10, 11, 12, 13 shown in FIG. 5, (i.e., they are shaped like a right-angle triangle) on the vertical (41) and horizontal side (42), but the third side (43) is not rectilinear but curved, (i.e., concave). This panel shape makes it possible to deviate the force of the fluid so that it does not directly strike the surface of the panel as in the prior examples of implementation, but will go around the side of the curved triangle and thus be deviated upwards, as shown by arrow F3 in FIG. 14. Such a device is even less likely to be caught by the force of the fluid and thus will be more firmly attached to the S support and will have fewer tendencies to detach.

The devices shown in FIGS. 5 to 10 and 14, 15, are intended to be attached in a removable way to the roofs of vehicles moving at speeds as high as 180 km/h and more. Therefore, when the vehicle is stopped, the device is placed, using the four magnets and once placed, this device will not detach from the roof, even when the vehicle is going at more than 180 km/h.

FIG. 11 shows a panel P that is intended to be placed on the ground, and is consequently stationary (motionless).

FIG. 12 shows a panel P which includes four support arms (51, 52, 53, 54) on a stationary vertical wall. Arms 52, 54 are placed on a surface in front of the vertical surface of panel P, while arms 51 and 53 are located on the vertical surface of panel P. This device is in conformity with the design as shown in FIG. 3. When the wind blows and strikes the panel P, springs (55 and 57) placed at the ends of arms 51 and 53, respectively, are compressed, while springs (56 and 58), placed at the end of the arms 52 and 54 are extended. If the wind blows in the opposite direction, springs 54 and 56 are extended, and spring 55 is compressed. In this way, no matter which way the wind blows, the panel will remain vertical.

The device shown in FIG. 13 is somewhat different from the preceding examples, because panel P is not flat but cylindrical. It is intended to attached to the ground by using four arms (61, 62, 63 and 64) which are connected to four springs (65, 66, 67, 68) attached by using four suction cups (69, 70, 71, 72) on the ground. When the wind blows in any direction, it exerts a force on the cylinder and as explained previously, two springs are then compressed and the two other springs are extended and in this way they keep panel P vertical.

In all the devices described above, the springs also function to maintain the lower edge of the panel away from the support, which also makes it possible to deviate part of the trajectory of the fluid and thus decrease its force of impact on the panel.

The set shown in FIGS. 16 and 17 consists of two devices in accordance with the present invention. It can be seen that the device includes a support arm (80) and two elastic mounting devices (81, 82) located at each end of the support arm (80). The end of each elastic device (81, 82) is connected to a repositionable and removable attachment device (83, 84), which is preferably a magnet, but which may also be a suction cup. These attachment devices (83, 84), are placed on the wall of a load (C) whose weight exerts a force (F5) upon the bottom which corresponds to the action of gravity upon the load and which can thus be regarded as exerting weight upon itself. The elastic device (82), placed on the bottom of the device, is subject to the force of extension (F6) and elastic device (83), placed higher than elastic device (82), is subject to a contracting force (F7).

The load is then held by the device. If the support arm 80 is displace upward, e.g. by means of a cable 85, the load is driven by the steadying device according to the invention. On FIG. 16, two devices are represented according to the invention, each constituted of a support arm and of at least two elastic devices provided with removable repositionable fastening devices at their extremities. These two devices are side by side and form an assembly permitting to steadying and displace load C. Preferably, both devices include articulations 86, 87, and more which allow for the device to be distorted and for a better distribution of the load.

On FIG. 18, a device is represented including many elastic devices 91, 92, 93, 94, 96, provided at their extremity with removable repositionable fastening means 96, 97, 98, 99, 100.

On FIG. 19, removable repositionable fastening devices 96, 97, 98, 99 and 100 are shown aligned. As for previous forms of embodiment, the elastic devices are interdependent with a supporting arm 101 which is driven by a cable 102. When cable 102 pulls supporting arm 101 up, spring 91 undergoes an extension while spring 100, more distant than the lower spring, undergoes a compression. Such device permits to steady the load and to drive it.

1. A displacement device for a repositionable load that is submitted to the thrust of a force comprising at least one support arm being linked at one extremity with an elastic mounting device whose opposite extremity is interdependent with a removable repositionable fastening device on the load, aforesaid support arm being driven into displacement by a driving device, said device being such that when the force exerts a trust on the load, at least one elastic mounting device undergoes a compression and at least one elastic mounting device undergoes an extension, while temporarily steadying the interdependent load with aforesaid displacement device.

2. A steadying device on a bracket of a panel perpendicular to a thrust of a fluid, in an appreciably vertical position, comprising at least two support arms, each having one extremity linked to the panel, and the opposite extremity linked to one extremity of an elastic mounting device whose opposite extremity is interdependent with a removable repositionable fastening device on the support, the elastic device being in a plan different from a plan of the panel in such a way that when the fluid exerts a thrust on the panel, at least one elastic mounting device undergoes a compression, and at least one elastic mounting device undergoes an extension, while steadying the panel in its initial position.

3. The displacement device of claim 1, further comprising at least three elastic devices.

4. The displacement device of claim 3, wherein the three elastic devices comprise springs.

5. The displacement device of claim 3, wherein the three elastic devices comprise a piston-cylinder system.

6. The displacement device of claim 1, wherein the removable repositionable fastening device comprises magnets.

7. The displacement device of claim 1, wherein the removable repositionable fastening device comprises a suction cup.

8. The steadying device of claim 2, wherein the support arms comprise L-supports having an appreciably triangular shape with one side interdependent with the panel.

9. The steadying device of claim 2, wherein the support arms are part of a support plate constituted by said arms coupled through their panel interdependent sides.

10. The steadying device of claim 2, wherein the panel comprises a double-sided panel or a cylindrical panel.

11. The steadying device of claim 2, wherein the panel in cross-section view forms a trapeze whose height is the device symmetry axis, whose large basis at both its extremities is interdependent with to elastic devices and whose sides are curved and concave.

12. The steadying device of claim 2, wherein the support is fixed.

13. The steadying device of claim 2, wherein the support is mobile.

14. An assembly to vertically displace a repositionable load submitted to its own weight comprising at least two devices placed side-by-side, each device comprising at least one support arm being linked at one extremity with an elastic mounting device whose opposite extremity is interdependent with a removable repositionable fastening device on the load, aforesaid support arm being driven into displacement by a driving device, said device being such that when the force exerts a trust on the load, at least one elastic mounting device undergoes a compression and at least one elastic mounting device undergoes an extension, while temporarily steadying the interdependent load with aforesaid displacement device.

15. An assembly to vertically displace a repositionable load submitted to its own weight, the assembly comprising:
at least one support arm being linked at one extremity with an elastic mounting device whose opposite extremity is interdependent with a removable repositionable fastening device on the load, aforesaid support arm being driven into displacement by a driving device, said device being such that when the force exerts a trust on the load, at least one elastic mounting device undergoes a compression and at least one elastic mounting device undergoes an extension, while temporarily steadying the interdependent load with aforesaid displacement device; and
a plurality of elastic, removable fastening device systems placed linearly.

16. The steadying device of claim 2, further comprising at least three elastic devices.

17. The steadying device of claim 16, wherein the three elastic devices comprise springs.

18. The steadying device of claim 16, wherein the three elastic devices comprise a piston-cylinder system.

19. The steadying device of claim 2, wherein the removable repositionable fastening device comprises magnets.

20. The steadying device of claim 2, wherein the removable repositionable fastening device comprises a suction cup.
